(19) United States
(12) Patent Application Publication
(10) Pub. No.: US 2008/0030375 A1
(43) Pub. Date: Feb. 7, 2008

(54) Aircraft wake safety management system

(75) Inventors: William B. Cotton, Lakeway, TX (US); Neal E. Fine, North Kingstown, RI (US)

Correspondence Address: TOBIN, CARBERRY, O'MALLEY, RILEY, SELINGER, P.C., 43 BROAD STREET, PO BOX 58, NEW LONDON, CT, 06320, US

(73) Assignee: Flight Safety Technologies, Inc., Mystic, CT (US)

(21) Appl. No.: 11/823,764

(22) Filed: Jun. 27, 2007

Related U.S. Application Data
(60) Provisional application No. 60/817,832, filed on Jun. 29, 2006.

(51) Int. Cl. G06F 19/00; G01W 1/00; G08B 21/00

(52) U.S. Cl. 340/945; 701/120; 73/178 T

(57) ABSTRACT

The disclosure is directed toward a method for safely managing aircraft separation. The method comprises a data integration host configured for: receiving aircraft information from a first aircraft; receiving weather data from a weather monitoring system; combining the aircraft information of the first aircraft with the weather data; formulating a position prediction of a wake vortex located within a critical safety volume of a runway; receiving from a sensor real time wake vortex data in a path of the first aircraft; comparing the real time wake vortex data to the position prediction to validate the position prediction and to formulate a determination of whether the wake vortex is present in the critical safety volume; and utilizing the determination to transmit spacing data to air traffic control, wherein the spacing data is at least one of standard wake vortex spacing and minimum radar spacing.

### PRIORITY CLAIM

This Application claims priority to Provisional Patent Application No. 60/817,832 entitled “Aircraft Wake Safety Management System” and filed on Jun. 29, 2006.

### BACKGROUND

The present invention relates generally to an aircraft wake safety management system that can utilize computer modeling, integrated with aircraft surveillance, weather data and real time wake vortex sensors (that detect wake vortices and other atmospheric disturbances that are hazardous to flying aircraft) to provide information to the air traffic control system that frees up additional runway capacity while ensuring the safety of flight from these hazards.

The man-made atmospheric hazard to aircraft known as wake turbulence is caused by the creation of lift from wings or rotors, and remains in the path behind the generating aircraft for up to several minutes. Wake turbulence, which also is not detectable by conventional radar, is characterized by two parallel vortices rotating in opposite directions and trailing behind and drifting below the aircraft that creates them. While all aircraft continuously generate wake vortices while in flight, their initial strength, and therefore the danger they pose to following aircraft, is a function primarily of the weight, speed, and wingspan of the generating aircraft. The higher the span loading (i.e., weight of aircraft divided by wingspan of aircraft) and the slower the speed, the stronger is the wake vortex. Thus, large transport airplanes flying slowly on final approach and initial departure pose the greatest hazard. The persistence of the wake vortex is determined by the stability of the atmosphere. In a very stable “smooth” air mass, the natural decay of the wake vortices may take up to two, three or more minutes. Air traffic authorities have mitigated this hazard by applying procedures to separate aircraft by increased distances and times according to their weight categories to allow sufficient time for wake vortex dissipation. These procedures provide the greatest separation to light aircraft following heavy ones, as this combination poses the greatest risk.

In the absence of operational means to locate and track wake vortices, following smaller category aircraft are kept safe by imposing increased arrival and departure separations between them and heavier aircraft in the terminal area. Since the behavior of wake vortices is not currently predicted, air traffic controllers use rigidly fixed distances (e.g., about 3 miles to about 6 miles) to separate different classes of aircraft. This causes air traffic delays that disrupt flight schedules and increase costs.

These increased spacing procedures are wasteful of scarce airport capacity because they reduce the number of airplanes that can take off or land during an hour, quite significantly when a mix of aircraft types is using the airport. While the safety of these flight operations will always be paramount, it has long been recognized that the wake vortices do not normally pose a flight risk even at minimum radar spacing between aircraft because they are either transported by the wind or by their natural self-induced descent out of the path of the following aircraft or broken up by ambient turbulence before the next aircraft gets there.

The wake turbulence increased spacing procedures in use have proven to be quite safe over the years, but some concerns remain. During visual flight conditions, pilots provide their own wake separation with no means to measure the distance between themselves and the location or the persistence of the wake vortices they are trying to avoid except through estimation based on the observed position of the generating airplane. Also, there are some conditions in which the air traffic procedures being applied may be inadequate and still permit a wake vortex encounter to occur. Accordingly, there is a need to regain the capacity lost to current procedures and to improve the operating safety in the presence of wake vortices.

It is well known in the art that the behavioral characteristics of the vortices behind a generating aircraft can be compared to the projected path of a following airplane to test for a potential wake encounter. When such is detected, the pilot of the following aircraft may be warned to take corrective action. (See U.S. patent application Ser. No. 10/565,531).

What is needed in the art is a system that can detect and resolve potential wake encounters in a manner that is compatible with the existing air traffic flow patterns. This system must provide guidance information for air traffic controllers to use in directing aircraft such that wake encounters are reliably avoided without putting additional space between airplanes.

### SUMMARY

The following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. Its sole purpose is to present some concepts of the present disclosure in a simplified form as a prelude to the more detailed description that is presented herein.

The disclosure is directed toward a method for safely managing aircraft separation. The method comprises coupling a data integration host to a memory and a transmitter. The data integration host is configured for: receiving aircraft information from a first aircraft for storage in the memory; receiving weather data from a weather monitoring system for storage in the memory; combining the aircraft information of the first aircraft with the weather data, such that the combining includes formulating a position prediction of a wake vortex located within a critical safety volume of a runway; receiving from at least one sensor real time wake vortex data in a path of the first aircraft; comparing the real time wake vortex data to the position prediction of the presence of the wake vortex to validate the position prediction and to formulate a determination of whether the wake vortex is present in the critical safety volume; and utilizing the determination to transmit spacing data to air traffic control, such that the spacing data is at least one of standard wake vortex spacing and minimum radar spacing.

The disclosure is also directed toward an aircraft wake safety management system. The system comprises a data integration host connected to a memory and a transmitter and instructions for directing the data integration host to: receive weather data from a weather monitoring system coupled to the data integration host; combine aircraft information received from a first aircraft with the weather data to formulate a position prediction of a presence of a wake vortex located within a critical safety volume of a runway; receive real time wake vortex data concerning the presence of the wake vortex from at least one sensor; compare the real time wake vortex data to the position prediction to validate the position prediction and to formulate a determination of whether the wake vortex is present in the critical safety volume; and utilizing the determination to transmit spacing data to air traffic control, such that the spacing data is at least one of standard wake vortex spacing and minimum radar spacing. The system further comprises at least one module comprising circuitry for transmitting the spacing data.

The disclosure is also directed toward a method of using an aircraft wake safety management system. The method comprises coupling a data integration host to a memory and a transmitter, such that the data integration host is configured for: receiving aircraft information from a leading aircraft for storage in the memory; receiving weather data from a weather monitoring system for storage in the memory; combining the aircraft information of the leading aircraft with the weather data, such that the combining includes formulating a future position prediction of a wake vortex from the leading aircraft; receiving aircraft information from a following aircraft for storage in the memory; predicting a future position of the following aircraft; determining if the future position of said following aircraft will intersect the future position prediction of the wake vortex generated by the lead aircraft at an intersection point; transmitting an alert to air traffic control relaying the intersection point; determining a course correction for the following aircraft to avoid the intersection with the wake vortex; and transmitting the course correction to the air traffic control.

The disclosure is also directed toward a method for safely managing aircraft separation at the minimum radar standard. The method comprises monitoring weather data from a weather monitoring system; transmitting said weather data to a data integration host; monitoring aircraft information from a leading aircraft and transmitting said aircraft information to said data integration host; monitoring weather persistence predictions from a terminal area weather forecasting system and transmitting said weather persistence predictions to said data integration host; combining said aircraft information with said weather data in said data integration host, wherein said combining includes formulating a position prediction and presence of a wake vortex pair; and comparing said wake position prediction to an intended flight path of a following aircraft to determine if at least one of a normal flying condition and a potential wake vortex conflict condition exists in said intended flight path of said following aircraft.

The disclosure is also directed toward a method of using an aircraft wake safety management system. The method comprises establishing a communication path between a data integration host processing system and a web server, said data integration host processing system connected to a memory and a transmitter, said data integration host processing system comprising instructions for directing said data integration host processing system to: receive weather data from a weather monitoring system coupled to said data integration host; receive aircraft data from a leading aircraft and a following aircraft coupled to said data integration host; combine aircraft information received from a leading aircraft with said weather data; formulate a position prediction of a presence of a wake vortex from said leading aircraft; receive real time wake vortex data concerning a presence of said wake vortex from at least one sensor; receive weather persistence predictions from a terminal area weather forecasting system; and compare said real time wake vortex data to said position prediction to formulate a value for use in determining whether, and for how long, minimum radar separation may be applied between all leading aircraft and a following aircraft operating in the terminal airspace.

The disclosure is also directed toward an aircraft wake safety management system. The system comprises a data integration host connected to a memory and a transmitter; instructions for directing said data integration host to: receive weather data from a weather monitoring system coupled to said data integration host; receive aircraft information from a leading aircraft in communication with said data integration host; receive said weather persistence predictions from a terminal area weather forecasting system coupled to said data integration host; combine said aircraft information with said weather data to formulate a position prediction of a presence of a wake vortex; and compare said position prediction to an intended flight path of a following aircraft to determine if at least one of a normal flying condition and a potential conflict condition exists in said intended flight path of said following aircraft.

### BRIEF DESCRIPTION OF THE FIGURES

Referring now to the figures, wherein like elements are numbered alike:

FIG. 1 is a side view of a runway and approach zone illustrating the critical safety volume of an exemplary embodiment of the aircraft wake safety management system;

FIG. 2 is a perspective view of an aircraft approaching the critical safety volume of an exemplary embodiment of the aircraft wake safety management system;

FIG. 3 is a block diagram illustrating an exemplary embodiment of the aircraft wake safety management system; and

FIG. 4 is a perspective view of a leading aircraft and a following aircraft in the terminal airspace outside of the critical safety volume of an exemplary embodiment of the aircraft wake safety management system.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

The present invention solves the problems of the prior art by comparing the path ahead of a following aircraft to the predicted location of the wake vortices left by the leading aircraft, providing flow compatible guidance to avoid potential conflicts with the wake vortices, validating through measurement the predicted wake vortex locations at critical points on the flight path, using a combination of active and passive wake vortex sensors to measure wake vortex locations, and providing information to air traffic controllers when weather conditions will require a reversion to wake spacing procedures between arriving and departing aircraft.

The present invention is an aircraft wake safety management system that provides air traffic controllers with information for the safe spacing of aircraft on approach, departure and in the airport terminal area, while re-capturing most of the runway capacity lost to current vortex spacing procedures. The aircraft wake safety management system information is available to controllers in each of the operating scenarios that is addressed by current air traffic control wake turbulence procedures (i.e., single and dual arrivals, single and dual departures, crossing runway operations, and airborne crossing and in-trail operations).

The aircraft wake safety management system predicts vortex behavior and determines if the vortex pair generated by a lead aircraft is in the flight path of a following aircraft. At critical points on the flight path on approach, measurements of actual vortex behavior are made and compared to the predictions for confirmation of aircraft wake safety management system output and possible alerting if, for any reason, the actual vortex behavior presents a possible hazard when it was not predicted to do so.

The aircraft wake safety management system relies on the monitoring of all relevant weather variables known to affect wake behavior, including total wind vector, wind gradients, wind shear, temperature gradients, and atmospheric turbulence. The aircraft wake safety management system can also utilize the patented SOCRATES® sensing system in combination with a light detection and ranging (LIDAR) sensor and perhaps other systems to create a wake measurement subsystem, which includes all wake vortex behaviors, including wake lateral transport, sink (or rise) and demise, to provide a more accurate assessment of wake position in the lateral, vertical and longitudinal dimensions, and a prediction of wake strength in the time dimension. Wake vortex sensors may be classified as active or remote passive. An active sensor interrogates the atmosphere through which an aircraft is known to have traversed to look for characteristics of the motion of the atmosphere that may be classified as motion due to a wake vortex, and tracked to determine the position of the vortex as a function of time. LIDAR is an example of an active sensor. A remote passive sensor determines if a vortex is present in the atmosphere based on information collected remotely, without actively interrogating the atmosphere through which that aircraft traversed. SOCRATES® is an example of a remote passive sensor. Active and remote passive sensors are known to complement one another because they rely on different tracking mechanisms. In a preferred embodiment, the present invention can include the use of both active and remote passive sensors.

The aircraft wake safety management concept for wake avoidance recognizes that when aircraft are spaced at the target minimum terminal area radar separation of three miles, the wake of the leading large, heavy or very heavy (i.e., jumbo) has not dissipated at the longitudinal position of the following aircraft during most weather conditions. Therefore, the dissipation mechanism is not frequently used in the aircraft wake safety management analysis algorithms. The aircraft wake safety management system also provides a safety alerting system, which, in addition to alerting air traffic controllers, could provide information on cockpit displays on the measured and predicted positions of the wakes from leading aircraft, alerting to the prediction of a potential wake vortex encounter on the current flight track and guidance to avoid the predicted encounter while not interfering with the normal flow of traffic.

When the aircraft wake safety management system recommends using the minimum radar separation, it is necessary to monitor the wake position relative to the position of a trailing aircraft in order to prevent encounters. The aircraft wake safety management system provides two modes of protection from wake vortex encounters: Strategic Mode and Tactical Mode. The Strategic Mode is used when the pair of aircraft under consideration is attempting to follow a defined three dimensional path in space such as an ILS (Instrument Landing System), MLS (Microwave Landing System), RNP (Required Navigation Performance) procedure, or any other procedure that requires an aircraft to follow a defined path in space. When following such defined paths, the airspace around the path is protected from encroachment of all hazards, within defined limits. If a flight strays outside these limits it is not protected and is required to abandon the procedure. The aircraft wake safety management system strategic algorithm predicts the motion of the wake vortices generated by leading aircraft with respect to the limits of the procedurally defined path in space (i.e., the critical safety volume), which the trailing aircraft intend to follow.

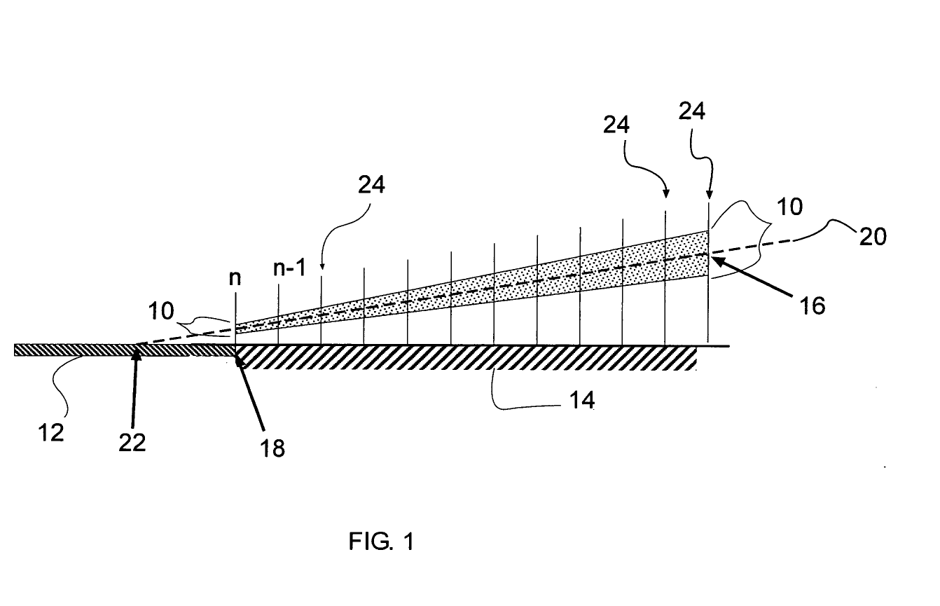

Referring to FIG. 1, a side view of a runway 12 and ground under the approach area 14 are illustrated to demonstrate the critical safety volume 10 for an aircraft (not shown) when utilizing the aircraft wake management system for safe spacing of aircraft. The critical safety volume 10 extends from a Stabilized Approach Point (SAP) 16 (where the aircraft passes through 1,000 foot altitude) to a runway threshold 18. The flight path 20 extends through the critical safety volume 10 to the touchdown point 22 located past the runway threshold 18. For the purpose of predicting and measuring the wake transport within and near the critical safety volume 10, the critical safety volume 10 is discretized into a series of vertical planes 24. When an aircraft (not shown) passes through each vertical plane 24, the future track of the vortices generated by that aircraft is predicted using the aircraft wake safety management system within that vertical plane. This vortex position data prediction by the aircraft wake management system requires, as input data, the aircraft wingspan, weight and speed, and the local wind speed and direction and turbulence levels as a function of height above the ground 14. Using the predicted vortex position data, the aircraft wake safety management software determines if the wake vortices will be outside of the protected airspace at the time at which the next aircraft is projected to pass through each vertical plane 24 (i.e., the predicted wake vortex motion).

In addition to these predictions, measurements of the vortex locations are collected at several “safety critical locations” in the strategic volume (i.e., the measured wake vortex motion) and compared to the predicted locations for validation. The aircraft wake safety management system includes at least two safety critical locations: the stabilized approach point, and the runway threshold. In a preferred embodiment, the aircraft wake safety management system uses an active wake vortex sensor at the runway threshold and the combination of at least one active sensor and at least one remote passive sensor at the stabilized approach point.

If comparison of the predicted wake vortex motion and measured wake vortex motion shows that the predictions are conservative (that is, the predicted wake vortex positions in a given vertical plane are not further from the critical safety volume than the measured positions at the time when the following aircraft is projected to pass through that vertical plane) and both the predictions and the measurements show the vortices to be clear of the protected airspace limits (i.e., the critical safety volume) before the following aircraft passage, then the guidance to air traffic control (ATC) will permit the use of minimum radar separation between any pair of aircraft. This condition must persist for some number of aircraft passages through the strategic volume (a typical number of passages is five). The decision to recommend reduced aircraft spacing is based solely on the consistent transport of the wake vortices out of the critical safety volume as predicted by the aircraft wake safety management system throughout the volume and measured at the safety critical locations.

If the predictions show that the weather conditions are not supporting the transport of the wake vortices away from the critical safety volume at the time of the following aircraft's expected passage, then the guidance to ATC will recommend that standard wake vortex spacing procedures be used.

If the validation shows that the predictions are not conservative (further from the flight path than the measured position) and the measured position shows the wake vortices will not be clear of the critical safety volume at the time of the following aircraft's passage, an alert will be issued to ATC to take control action to protect the following aircraft, such as a missed approach or a “breakout.”

The Tactical Mode is generally used when the aircraft are in vectored or in visual flight and not required to follow a defined path in space. When operating in the Tactical Mode, the aircraft wake safety management system algorithms predict the location of the wake vortices from the leading aircraft based on the aircraft's actual path in space as determined by aircraft surveillance and weather information taken from the same leading aircraft, via data link, or others operating in nearby temporal and spatial locations. Depending on the surveillance system used, the velocity vector of the trailing aircraft is either measured directly or projected into the future from a short period of surveillance and compared to the predicted wake vortex location for the same period. The aircraft wake safety management system monitors for an intersection between the predicted path of the wake vortex pair generated by the leading aircraft and the predicted path of the trailing aircraft. Tactical separation is used anywhere in the terminal area that standard wake turbulence separation will not be applied in order to satisfy an air traffic requirement, whether it be to establish spacing on final approach, separating successive departures, or managing crossing paths in the airspace at the same altitude. When the aircraft wake safety management system shows no intersection of the wake vortex positions and the predicted path of the following aircraft, the status information for ATC shows that minimum radar separation may be used. If an intersection is predicted, guidance information is issued to the appropriate controller who sends a control instruction to the pilot of the following aircraft. Pilots of suitably equipped aircraft may receive the instruction directly via data link. A small control action, determined with respect to the position in the traffic pattern and the locations of other nearby aircraft, issued either by ATC or directly to the pilot of the following aircraft, will clear the alert without disruption to the traffic flow.

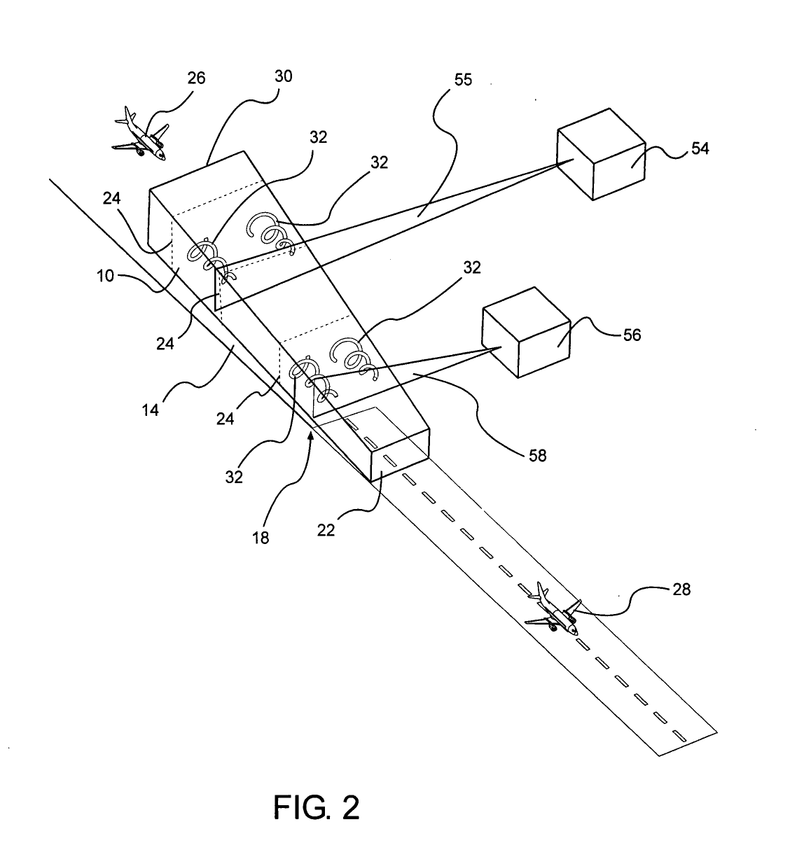

Referring now to FIG. 2, the Strategic Mode of the aircraft wake safety management system is illustrated in the critical safety volume 10 of final approach where wake vortex measurements are made. Incoming aircraft 26 is the following aircraft to the leading (or wake-generating) aircraft 28 Although the following illustrates the use of the aircraft wake safety management system with an incoming aircraft 26, the system can also be utilized with a departing aircraft and anywhere else in the airport terminal where less than traditional wake vortex separation is applied by ATC. On final approach, when incoming aircraft 26 reaches its minimum approach speed at the stabilized approach point (or SAP) 30, the initial strength of wake vortices 32 is greatest while the maneuverability of the incoming aircraft 26 is restricted (due to low speed and proximity to the ground 14). The critical safety volume 10 is located between the stabilized approach point 30 and the runway touchdown point 22 of the incoming aircraft 26. In certain atmospheric conditions, persistent wake vortices 32 can linger in the critical safety volume 10 causing a threat to the incoming aircraft 26.

The aircraft wake safety management system specifically is able to determine if the incoming aircraft 26 is likely to encounter a wake vortex 32. In most cases, the wake vortex 32 will descend below the flight path (see numeral 20 in FIG. 1) of the incoming aircraft 26, or will be transported away (i.e., outside the critical safety volume 10) by the wind. The aircraft wake safety management system verifies that the wake vortex 32 will not be encountered by the incoming aircraft 26 through predicted wake behavior, and continuously validates those predictions at critical points (i.e., vertical planes 24) along the flight path.

The persistence of the atmospheric conditions is also monitored by utilizing the larger scale atmospheric conditions to create a weather persistence prediction 42. The purpose of the persistence prediction is to provide stability to the arrival traffic flow established by ATC. The aircraft wake safety management system achieves the persistence prediction elements of the system by utilizing the atmospheric conditions (e.g., wind, turbulence and temperature, their spatial and temporal variations) and the parameters of the wake generating aircraft (e.g., the position, velocity, weight, and wingspan). The persistence prediction will provide an estimate of the length of time for which the current aircraft wake safety management system separation status (e.g., radar separation or standard wake separation) will persist. Data from local ground-based weather sensors, for example the Terminal Doppler Weather Radar (TDWR) and the Integrated Terminal Weather System (ITWS), is used in combination with the Rapid Update Cycle (RUC) software developed by the National Oceanic and Atmospheric Administration (NOAA) to predict the persistence of the parameters responsible for transporting the wake vortices out of the strategic volume. Parameters of interest include the local wind speed and direction, the turbulence level, and the atmospheric stratification. The persistence prediction consists of forecasted values for the parameters of interest in a “sliding time window” of about 20 to about 30 minutes duration. When the parameters are forecast to change the wake vortex separation operational status, the time to this change will count down on the controller's status information display.

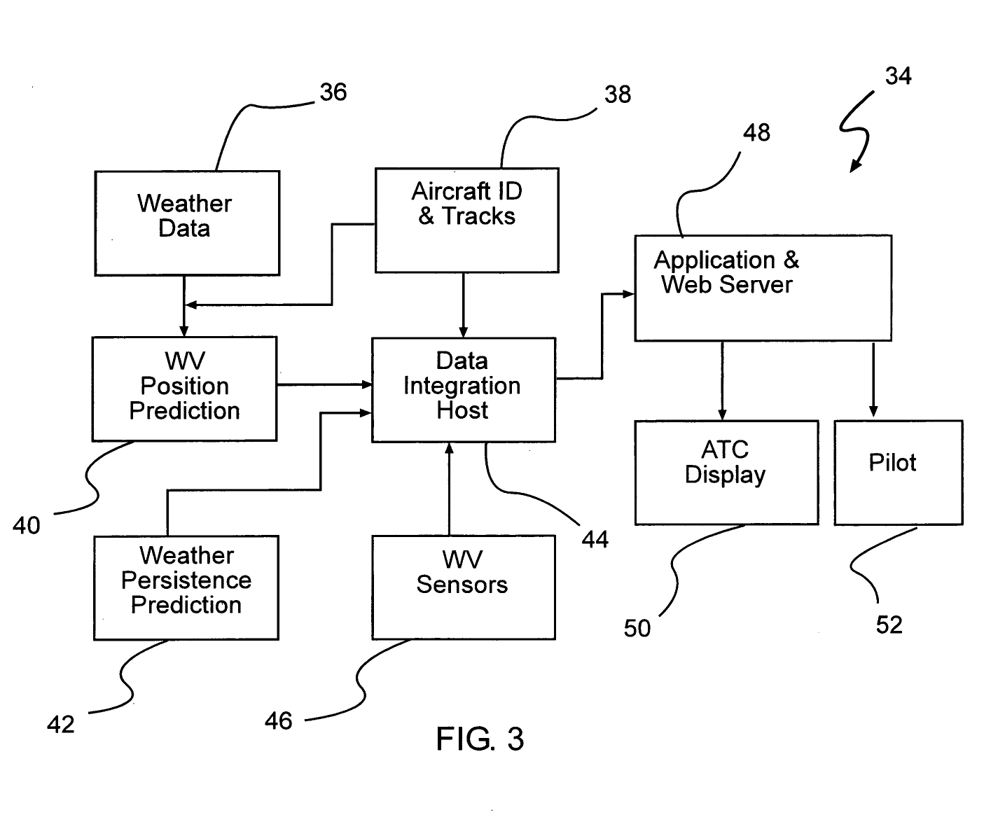

Referring now to FIG. 3, a block diagram illustrates an exemplary embodiment of the aircraft wake safety management system 34. The aircraft wake safety management system 34 utilizes atmospheric sensing (or weather data) 36 that is combined with individual aircraft identification and track information to create a prediction of the presence (or absence) of a wake vortex hazard to a following aircraft, based on wake vortex lateral and vertical transport (or dissipation) behavior. This function is provided by anemometer and wind profiler measurements, and by wind and turbulence data sensed on board these or other aircraft and transmitted to the aircraft wake safety management system 34 by data link (e.g. the ACARS link or ADS-B). Algorithms use this data to predict the future position of the vortices within vertical “slices” of the atmosphere, extending from the altitude of the generating aircraft at the time it passed through the vertical plane to the ground.

The aircraft wake safety management system processor receives aircraft surveillance information (or aircraft type and track) 38 on the track of the incoming aircraft 26 using an Automatic Dependent Surveillance-Broadcast (ADS-B) system or transponder-based multi-lateration surveillance system, or the like. An ADS-B system operates by having aircraft receive GPS signals and use them to determine the aircraft's precise location in the sky and its instantaneous velocity vector. The system converts that position into a unique digital code and combines it with other data on the aircraft's “state” (e.g., type of aircraft, its velocity vector, its ID, and its position). The code containing all of this data is automatically broadcast from the aircraft once per second. Aircraft equipped to receive the data and ADS-B ground stations up to 200 miles away receive these broadcasts. Pilots of suitably-equipped aircraft can see this information on their cockpit display screens. Air traffic controllers can see the information on their displays once modified to receive this information. This data is utilized by the aircraft wake safety management system to make a vortex prediction 40 of the presence and location of the wake vortices behind the leading aircraft. Using ADS-B or multi-lateration, the aircraft wake safety management system 34 can also track the trailing aircraft's position relative to the predicted location of the leading aircraft's vortices, which is used in the Tactical Mode of the aircraft wake safety management system 34 to give an indication of whether guidance to avoid a predicted wake encounter must be provided or not.

A data integration host 44, comprising at least data processing algorithms and software, receives (or is instructed to receive) the wake vortex prediction 40, the weather persistence prediction 42, aircraft surveillance information 38 and real time wake vortex location information from several wake vortex sensors 46 for storage in a memory 45. This wake vortex prediction 40, the aircraft tracks 38, and the real time wake vortex data are compared to validate the wake vortex prediction and to determine if the strategic control volume will be clear of wake vortices in time for the next aircraft to pass through. An operating advisory (e.g., a spacing determination or determination) computed in the data integration host 44 is then transmitted via an application and web server (or transmitter) 48 to an ATC display 50 for the use of the “approach” and “local” controllers, maintenance personnel, and for further dissemination via data link to incoming or departing pilots 52 of properly equipped aircraft.

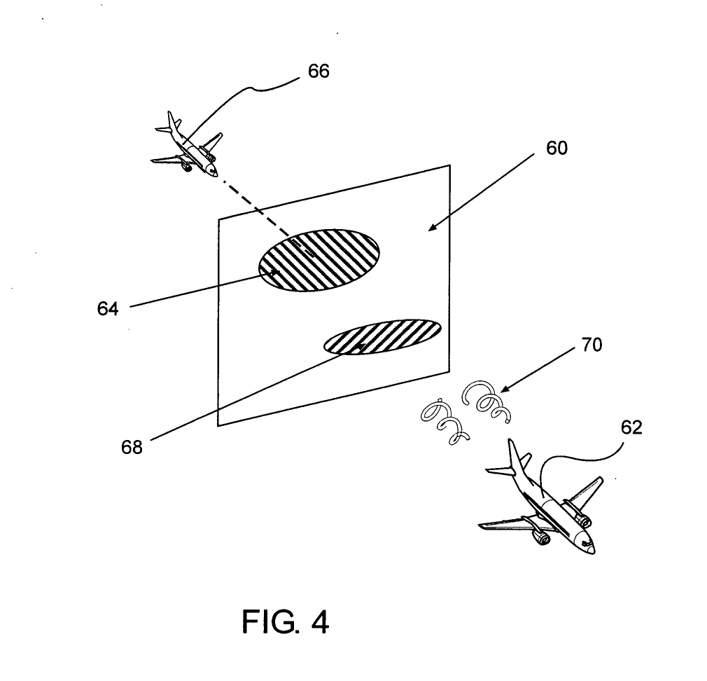

In the preferred embodiment of the Tactical Mode, the aircraft wake safety management system 34 establishes an object oriented approach to the prediction of vortex encounters. In predicting the potential encounter between a following aircraft and the wake vortices of a leading aircraft, a mix of deterministic and statistical algorithms are used to predict the future location of both the trailing aircraft and the lead wake vortices. Referring now to FIG. 4, a “prediction plane” 60 is defined by the vertical plane which includes the point in space where the nose of the trailing aircraft is projected to be about 15 to about 30 seconds in the future (a preferred value is about 20 seconds into the future), where the position of the following aircraft 62 nose is projected from past history of known locations derived from surveillance data, or directly from the ADS-B computed velocity vector when such is available. An elliptical or rectangular region 64 in that prediction plane is then computed such that the probability that the aircraft (from wing-tip to wing-tip) will pass through that region is between about 0.9 and about 1.0 (with a preferred value being about 0.99). The location of the wake vortices from the lead aircraft 66 is then computed in the prediction plane using deterministic algorithms, which assume that the wake vortices are two-dimensional point wake vortices, taking into account their initial strength, which is proportional to the aircraft weight and inversely proportional to the aircraft speed and wingspan. A region 68 in the prediction plane is then computed such that the probability that the wake vortices 70 are completely contained within that region is between about 0.9 and about 1.0 (with a preferred value being about 0.99). If the two regions so defined overlap, and the strength of the vortices is predicted to be above the level of the background turbulence, then a wake encounter is predicted to occur at that time. If the two regions do not overlap, or if the strength of the vortices is predicted to be at or below the level of the background turbulence, then a wake encounter is not predicted to occur at that time.

Throughout the area of interest, wherever aircraft are “in-trail” (i.e., following each other in a line on the same nominal path), merging to an in-trail condition or on crossing paths near the same altitude, the velocity vectors of each follower is compared to the wake track of its leader, along with the aircraft type information of both aircraft in each pair. Any potential intersection of a wake track with a following aircraft predicted position (projected about 20 seconds ahead) will result in the generation of guidance information to the controller of the affected aircraft to facilitate corrective action, if necessary. The location of the potential encounter can also be displayed graphically to the pilot of properly equipped following aircraft, along with notification. Since the control loop time within the cockpit is less than when an air traffic controller makes the notification, a projection of about 10 to about 15 seconds along the velocity vector might suffice for the airborne implementation, reducing the rate of nuisance notifications.

When the aircraft wake safety management system is in use and calling for standard radar separation to be applied among all aircraft, predictions of wake encounters will be almost as rare as real encounters are in this airspace today. That expectation is based on the premise that it is the sink of the vortices even more than the decay that protects against encounters under current procedures. Two other factors that will reduce the frequency of predicted wake encounters are:
a. The aircraft wake safety management system logic is only applied when the follower is of a smaller wake category than the leader; and
b. The aircraft wake safety management system logic is not applied until the separation between the aircraft pair under consideration is less than standard wake separation and less than 1000 feet vertical.
   The aircraft wake safety management system checks for these conditions to exist continuously and invokes deconfliction logic should the prediction call for it.

In addition to using the object oriented approach, in the Strategic Mode the aircraft wake safety management system can also utilize a variety of sensors (e.g., the SOCRATES® sensing system and/or a LIDAR system or other systems) to validate the vortex movement predictions through actual measurements of the wake vortices 32 at safety critical locations near the runway 12. Referring again to FIG. 2, in a preferred embodiment of the strategic mode, the aircraft wake safety management system 34 also utilizes the SOCRATES® sensing system 54 alone or in combination with a LIDAR system 56 to create a wake measurement system, which includes all wake vortex behaviors, including wake sink (and rise) and demise, to provide a validation of the wake position in the lateral, vertical and longitudinal dimensions, and an assessment of wake strength in the time dimension. SOCRATES® uses an array of laser transmitters and retro-reflectors to form an acoustic beam 55 which is used to detect and track wake vortices. SOCRATES® is an example of a remote passive wake vortex sensor.

In another embodiment, a preferred sensor that can be utilized with the aircraft wake safety management system is a LIDAR sensor 56. The LIDAR sensor 56 is used to determine the distance to a wake vortex 32 using laser pulses 58. The range and elevation to the wake vortex 32 is determined by measuring the time delay between transmission of a pulse and detection of the reflected signal. The LIDAR instrument transmits light out to a target. The transmitted light interacts with airborne particulates. Some of this light is reflected/scattered back to the instrument where it is analyzed. The Doppler shift of the reflected light enables the velocity field characteristic of the wake vortices to be detected. The time for the light to travel out to the target and back to the LIDAR sensor is used to determine the range to the target.

The LIDAR sensor utilizes electromagnetic radiation at optical frequencies. The radiation used by LIDAR is at wavelengths which are about 10,000 to about 100,000 times shorter than that used by conventional radar. Electromagnetic radiation scattered by the target is collected and processed to yield information about the target and/or the path to the target. LIDAR is an example of an active wake vortex sensor.

Both the SOCRATES® system and the LIDAR sensors can be battery powered or hardwired. Additionally, the data from the sensors can be transmitted either wireless or hardwired to the aircraft wake safety management system server, which will be powered from conventional sources.

The aircraft wake safety management system contains an integral safety alerting system. During the Strategic Mode, a controller alert is issued in the rare event that wake vortex measurements have shown the predictions to be non-conservative (i.e., hazardous, when predicted to be safely separated). This safety alerting system can include airborne elements that provide information to cockpit displays on the current and predicted positions of leading aircraft and their wakes from which pilots may take informed and safe actions to avoid potential wake vortex encounters. This is utilized when the appropriate spacing for wake vortex safety is about to be compromised. If an alert is given, the controller can take appropriate action to separate the effected airplane from the potential wake vortex encounter.

This disclosure has been presented in a single runway landing scenario. The departure scenario generally uses only the lateral transport mechanism in the Strategic Mode for vortex removal as the vertical flight profile of a departing aircraft is performance-based and cannot be known in advance. When runways are very closely spaced (i.e., less than about 2,500 feet apart), the runways are said to be “wake vortex dependent” and are treated as a single runway for wake turbulence purposes. The aircraft wake safety management system for “dual” runways checks for transport from one approach or departure path to the other, in addition to the single, along-track case.

When crossing runways are used, the location of the intersection determines whether it is possible for airplanes using both runways to be airborne over the intersection. The aircraft wake safety management system uses the transport mechanisms to determine presence or absence of a hazard. In cases where flight paths to runways at different airports cross at low altitude, any of the three mechanisms can be used to evaluate the risk in the airspace near the crossing point. In general, during radar vectored or visual flight in the terminal area, the Tactical Mode of the aircraft wake safety management is used to ensure safety from wake vortex hazards.

The aircraft wake safety management system will issue a status value (for example, ‘R’ or ‘W’) to air traffic control, where ‘R’ means that all aircraft may be separated using standard radar separation, and ‘W’ means that standard wake vortex separation should be maintained. Radar separation is the default condition and will be available when the following conditions are met:

1. Both vortices have exited the strategic control volume at all prediction planes for the previous five landings prior to the time when the following aircraft was predicted to pass through each prediction plane if the aircraft were separated by three nautical miles (3 nm).

2. Wherever prediction and measurement planes coincide, the predictions have been shown to be conservative for each of the five previous landings.

The aircraft wake safety management system provides very substantial benefits at every airport used by multiple wake categories of aircraft. Most significantly, pilots will now have a backup to their judgments regarding safe separation from the wakes of the airplanes they follow or fly alongside. Every close operation will have an automated system ensuring a very low risk of wake vortex encounter. When the number of flights increases in the future and the types of aircraft continues to vary, the value of using the aircraft wake safety management system to maintain safe operations increases significantly.

The capacity gained through implementation of the aircraft wake safety management system allows the runway acceptance rate once again to be governed by runway occupancy times, not terminal area or final approach wake vortex spacing during nearly all weather conditions. The capacity gained at any one airport is dependent on the traffic mix, the airport runway configuration, and the current operational procedures. However, the changeover in capacity limiting factors will fundamentally improve the approach capacity equation. On departure, the introduction of noise abatement routes that are flown using Flight Management Systems is already reducing departure capacity for many runways in all weather conditions below that available when controllers can “fan” successive departures to alternate headings after take-off. These procedures, when coupled with current wake vortex separation requirements, negatively impact the departure capacity of the affected runways. The aircraft wake safety management system maximizes the recapture of the capacity lost through the introduction of these new noise procedures.

The aircraft wake safety management system permits the maximum capacity of a runway to be utilized without applying the current artificial limitation of wake turbulence spacing criteria. Instead of using four, five, or six miles of separation between airplanes of different weight categories, all aircraft could be separated by only about three miles (or about 2½ miles where local approval permits). The most noticeable effect of the aircraft wake safety management system is delay reduction as airplanes may be safely brought in closer together which, in turn, allows the airport to more easily accommodate the airline schedules.

The benefit of successful use of a combined SOCRATES®/LIDAR sensing system as components of the aircraft wake safety management system is the ability to safely reduce the separation between aircraft and hazardous wakes through actual knowledge of wake locations rather than predictions alone. Utilizing the SOCRATES® sensing system with the aircraft wake safety management system provides remote, eye-safe detection of aircraft wake vortices, improved detection tracking, and an independent localization concept. The aircraft wake safety management system dramatically improves both safety and efficiency of airport and terminal operations at precisely those locations that need these benefits the most. Other wake sensing systems, including RASS, Sodar, X-Band radar, windline anemometers and others may be used as part of the aircraft wake safety management wake measurement subsystem.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A method for safely managing aircraft separation comprising:
coupling a data integration host to a memory and a transmitter, said data integration host configured for:
receiving aircraft information from a first aircraft for storage in said memory;
receiving weather data from a weather monitoring system for storage in said memory;
combining said aircraft information of said first aircraft with said weather data, wherein said combining includes formulating a position prediction of a wake vortex located within a critical safety volume of a runway;
receiving from at least one sensor real time wake vortex data in a path of said first aircraft;
comparing said real time wake vortex data to said position prediction of said presence of said wake vortex to validate said position prediction and to formulate a determination of whether said wake vortex is present in said critical safety volume; and
utilizing said determination to transmit spacing data to air traffic control via said transmitter, said spacing data is at least one of standard wake vortex spacing and minimum radar spacing.

2. The method of claim 1, further comprising:
receiving weather persistence predictions from a terminal area weather forecasting system, said weather persistence predictions predict a duration of local weather conditions, wherein said duration is utilized for recommended aircraft spacing status to be used by said air traffic control.

3. The method of claim 2, further comprising:
transmitting said weather persistence prediction to at least one of said air traffic control facilities, a following aircraft, and ground personnel for use in determining a duration of said spacing data.

4. The method of claim 1, wherein said at least one sensor is at least one of a lidar sensor, an opto-acoustic sensing system, and an array of conventional microphones.

5. The method of claim 1, further comprising:
transmitting said spacing data to at least one of air traffic control facilities, a following aircraft, and ground personnel.

6. The method of claim 1, further comprising:
activating a safety alert system upon transmitting said determination.

7. The method of claim 1, wherein said aircraft information is selected from at least one of size, weight, wingspan, and speed.

8. The method of claim 1, further comprising:
receiving real time wake vortex data from another sensor communicating with said at least one sensor.

9. The method of claim 8, wherein said another sensor comprises at least one of a lidar sensor, an opto-acoustic sensing system, and an array of conventional microphones.

10. An aircraft wake safety management system comprising:
a data integration host connected to a memory and a transmitter;
instructions for directing said data integration host to:
receive weather data from a weather monitoring system coupled to said data integration host;
combine aircraft information received from a first aircraft with said weather data to formulate a position prediction of a presence of a wake vortex located within a critical safety volume of a runway;
receive real time wake vortex data concerning said presence of said wake vortex from at least one sensor;
compare said real time wake vortex data to said position prediction to validate said position prediction and to formulate a determination of whether said wake vortex is present in said critical safety volume; and
utilizing said determination to transmit spacing data to air traffic control via said transmitter, said spacing data is at least one of standard wake vortex spacing and minimum radar spacing; and
at least one module comprising circuitry for transmitting said spacing data.

11. The aircraft wake safety management system of claim 10, further comprising:
receive weather persistence predictions from a terminal area weather forecasting system, said weather persistence predictions predict a duration of local weather conditions, wherein said duration is utilized for recommended aircraft spacing status to be used by said air traffic control.

12. The aircraft wake safety management system of claim 11, further comprising:
transmit said weather persistence prediction to at least one of said air traffic control facilities, said following aircraft, and ground personnel for use in determining a duration of said spacing data.

13. The aircraft wake safety management system of claim 10, wherein said at least one sensor is at least one of a lidar sensor, an opto-acoustic sensing system, and an array of conventional microphones.

14. The aircraft wake safety management system of claim 10, further comprising:
transmit said spacing data to at least one of air traffic control facilities, a following aircraft, and ground personnel.

15. The aircraft wake safety management system of claim 10, further comprising:
activate a safety alert system upon transmitting said determination.

16. The aircraft wake safety management system of claim 10, wherein said aircraft information is selected from at least one of size, weight, wingspan, and speed.

17. The aircraft wake safety management system of claim 10, further comprising:
receive real time wake vortex data from another sensor communicating with said at least one sensor.

18. The aircraft wake safety management system of claim 17, wherein said another sensor comprises at least one of a lidar sensor, an opto-acoustic sensing system, and an array of conventional microphones.

19. A method of using an aircraft wake safety management system comprising:
coupling a data integration host to a memory and a transmitter, said data integration host configured for:
receiving aircraft information from a leading aircraft for storage in said memory;
receiving weather data from a weather monitoring system for storage in said memory;
combining said aircraft information of said leading aircraft with said weather data, wherein said combining includes formulating a future position prediction of a wake vortex from said leading aircraft;
receiving aircraft information from a following aircraft for storage in said memory;
predicting a future position of said following aircraft;
determining if said future position of said following aircraft will intersect said future position prediction of said wake vortex generated by said lead aircraft at an intersection point;
transmitting an alert to air traffic control relaying said intersection point;
determining a course correction compatible with traffic flow for said following aircraft to avoid said intersection with said wake vortex; and
transmitting said course correction to said air traffic control.

20. The method of claim 19, wherein said aircraft information is selected from at least one of size, weight, wingspan, and speed.
